(19) United States
(12) Patent Application Publication
(10) Pub. No.: US 2022/0119315 A1
(43) Pub. Date: Apr. 21, 2022

(54) M7 LTCC-Silver System And Related Dielectric Compositions For High Frequency Applications

(71) Applicant: Ferro Corporation, Mayfield Heights, OH (US)

(72) Inventors: Ellen S. Tormey, West Windsor, NJ (US); Peter Marley, Farmington, NY (US); Chao Ma, Collegeville, PA (US); John Maloney, Solon, OH (US); Yi Yang, Fort Washington, PA (US); Orville W. Brown, Escondido, CA (US); Srinivasan Sridharan, Strongsville, OH (US)

(21) Appl. No.: 17/434,232

(22) PCT Filed: Feb. 4, 2021
(86) PCT No.: PCT/US2021/016566

§ 371 Date: Aug. 26, 2021

Related U.S. Application Data
(60) Provisional application No. 63/145,130, filed on Feb. 3, 2021.
(60) Provisional application No. 62/970,522, filed on Feb. 5, 2020.

(51) Int. Cl. C04B 35/20; H01B 3/10

(52) U.S. Cl. CPC C04B 35/20; H01B 3/10; C04B 2235/3281; C04B 2235/96; C04B 2235/5445

(57) ABSTRACT

LTCC devices are produced from dielectric compositions include a mixture of precursor materials that, upon firing, forms a dielectric material having a magnesium-silicon oxide host. An associated Ag system for LTCC conductors is also described.

### BACKGROUND OF THE INVENTION

### 1. Field of Invention

This invention relates to dielectric compositions, and more particularly to Magnesium-Silicon-Calcium oxide based dielectric compositions that exhibit a dielectric constant K=4-12 or alternately up to about 50, with very high Q factor at GHz high frequencies and that can be used in low temperature co-fired ceramic (LTCC) applications with noble metal metallization.

The Inventors sought to develop an environmentally friendly (Lead free, Cadmium free, and Phthalate free) LTCC-Silver Cofirable System that fires at <900° C., for example, 825-850° C. for 5G wireless applications and other high frequency applications (5G frequency range: 3-6 GHz and 20-100 GHz).

### 2. Description of Related Art

The state of the art materials for LTCC systems in wireless applications include dielectrics with dielectric constant K=4-8 and with Q factors around 500-1,000 at the measuring frequency of 1 MHz. This is generally achieved by using a ceramic powder mixed with a high concentration of a BaO—CaO—B₂O₃ low softening temperature glass which allows low temperature (875° C. or lower) densification of the ceramic. This large volume of glass can have the undesirable effect of lowering the 0 value of said ceramic.

State of the art cofirable LTCC/Ag systems exist in the market, including Ferro A6M, A6ME, and L8 and also DuPont™ 9K7 and 951, but these systems have lower strength, lower thermal conductivity, and higher dielectric loss. Additionally, the loss is not as stable as that of the inventive systems over a wide frequency range.

### SUMMARY OF THE INVENTION

This invention relates to dielectric compositions and related Ag conductors, and more particularly to a system of magnesium-silicate-calcium based dielectric compositions that exhibit a dielectric constant K=5-10 with a high Q factor at high frequencies (GHz) that can be used in low temperature co-fired ceramic (LTCC) applications with noble metal metallization. The Q factor is the reciprocal of the dielectric loss tangent (Df). The Qf value is a parameter used to describe the quality of a dielectric, typically at frequencies in the GHz range. Of can be expressed as Qf=Q·f, where the measurement frequency f (in GHz) is multiplied by the Q factor at that frequency. There is growing demand for dielectric materials with very high Q values greater than 500 or even 1000 at frequencies of greater than 10 GHz for high frequency applications.

Broadly, the ceramic material of the invention includes a host which is made by mixing appropriate amounts of MgO and SiO₂ (or precursors of the foregoing), milling these materials together in an aqueous medium to a particle size D₅₀ of about 0.2 to 5.0 microns. This slurry is dried and calcined at about 800 to 1250° C. to form a host material including MgO and SiO₂. The resultant host material is then mechanically pulverized and mixed with fluxing agents and again milled in an aqueous medium to a particle size D₅₀ of about 0.5 to 1.0 μm. The milled ceramic powder is dried and pulverized to produce a finely divided powder. The resultant powder can be pressed into cylindrical pellets and fired at temperatures of about 750 to about 900° C., preferably about 775 to about 875° C., more preferably about 825 to about 850° C.

The firing is conducted for a time of about 1 to about 50 minutes, preferably about 5 to about 30 minutes, more preferably about 10 to about 50 minutes.

An embodiment of the invention is a composition comprising a mixture of precursor materials that, upon firing, forms magnesium-silicon-oxide host material that is free of any or all of the following, preferably free of all: lead, cadmium, zinc, manganese, bismuth, titanium, arsenic, and mercury. The host, by itself, or in combination with other metal containing compounds, such as oxides or fluorides, such as oxides or fluorides of Ca and/or Li, can form a dielectric material.

All compositions of the invention are free of at least one of the following in any chemical or physical form: lead, cadmium, zinc, manganese, bismuth, titanium, arsenic. In preferred embodiments, the compositions are free of more than one of the foregoing, and in the most preferred embodiment is free of all. The organic portion is free of phthalates.

An embodiment of the invention may include more than one host or a choice of hosts disclosed in WO 2020-014035, commonly owned, and incorporated herein by reference in its entirety.

A dielectric material of the invention results from the mixing and firing of 85-95 wt % of a host material disclosed herein together with (a) H₃BO₃ or B2O3; (b) at least one alkali fluoride; (c) at least one alkaline-earth fluoride and (d) CuO. Various combinations of F-containing salts together with various Li-containing or Ca-containing salts or oxides may be combined to reach desired levels of Li, Ca, and F in the final product of the invention. All inventive compositions and their intermediates disclosed herein contain none of the following in any form: lead, cadmium, zinc, manganese, bismuth, titanium, arsenic.

Conductors

The formulations for the Ag conductor pastes (surface, buried and via) for which properties are shown in the table above are presented in Tables 4-6. The Ag conductors are made by mixing together Ag powder(s) with filler materials (ceramic and/or glass), organic vehicle, dispersant and solvent and then 3-roll milling to form a thick film paste which is screen printed onto to the ceramic green tape and then dried at 125° C. Multilayer parts are made by stacking and isostatically laminating Ag-printed green tape layers and then firing in air at 825-850° C.

Silver conductor pastes may include silver flake(s); silver powder(s); a glass frit composition, which may include a dielectric formulation disclosed herein, and an organic component. The organic component includes a vehicle, a solvent and an emulsifier.

Useful Silver Constituents are found in the following Table 1.

TABLE 1
Silver Constituents

| Material in weight % | D₅₀ in μm | D₅₀ in μm |
|---|---|---|
| Ag Flake 1 | 0.4-0.9 | 0.6-0.8 |
| Ag Powder 1 | 2.6-6 | 3-5 |
| Ag Powder 2 | 0.6-2.5 | 0.7-2 |
| Ag Powder 3 | 0.1-0.55 | 0.2-0.5 |
| | Avg. PS in μm | Avg. PS in μm |
| Ag Powder 4 | 1-3.8 | 1.5-3.5 |

In the table above, the measurements for D₅₀ or Average Particle Size (Ave. PS) are not to be understood as forming embodiments of the invention by column; each particle (flake or powder) is to be taken separately, and various embodiments of the invention may include silver conductors using one or more of the flakes or powders noted in the table.

For each compositional range bounded by zero weight percent, the range is considered to also teach a range with a lower bound of 0.01 wt % or 0.1 wt %. A teaching such as 60-90 wt % Ag+Pd+Pt+Au means that any or all of the named components can be present in the composition adding up to the stated range.

In another embodiment, the present invention relates to a method of forming an electronic component comprising: applying any dielectric paste disclosed herein to a substrate; and firing the substrate at a temperature sufficient to sinter the dielectric material.

In another embodiment, the present invention relates to a method of forming an electronic component comprising applying particles of any dielectric material disclosed herein to a substrate and firing the substrate at a temperature sufficient to sinter the dielectric material.

In another embodiment, a method of the invention includes forming an electronic component comprising:
(a1) applying any dielectric composition disclosed herein to a substrate or
(a2) applying a tape comprising any dielectric composition disclosed herein to a substrate or
(a3) compacting a plurality of particles of any dielectric composition disclosed herein to form a monolithic composite substrate; and
(b) firing the substrate at a temperature sufficient to sinter the dielectric material.

A method according to the invention is a method of co-firing at least one layer of any dielectric material disclosed herein having a dielectric constant greater than 7 in combination with at least one alternating separate layer of tape or paste having a dielectric constant of less than 7 to form a multi-layer substrate wherein alternating layers have differing dielectric constants.

It is to be understood that each numerical value herein (percentage, temperature, etc.) is presumed to be preceded by “about.” In any embodiment herein the dielectric material may comprise different phases, for example crystalline and amorphous in any ratio, for example 1:99 to 99:1, (crystalline:amorphous) expressed in either mol % or wt %. Other ratios include 10:90, 20:80, 30:70, 40:60, 50:50, 60:40, 70:30, 80:20 and 90:10 as well as all values in between. In one embodiment the dielectric paste includes 10-30 wt % crystalline dielectric and 70-90 wt % amorphous dielectric.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE INVENTION

LTCC (Low Temperature Co-fired Ceramic), is a multi-layer, glass ceramic substrate technology which is co-fired with low resistance metal conductors, such as Ag, Au, Pt or Pd, or combinations thereof, at relatively low firing temperatures (less than 1000° C.). Sometimes it is referred to as “Glass Ceramics” because its main composition may consist of glass and alumina or other ceramic fillers. Some LTCC formulations are recrystallizing glasses. Glasses herein may be provided in the form of frits which may be formed in situ or added to a composition.

A tape cast from a slurry of dielectric material is cut, and holes known as vias are formed to enable electrical connection between layers. The vias are filled with a conductive paste, such as any silver paste disclosed herein. Circuit patterns are then printed, along with co-fired resistors as needed. Multiple layers of printed substrates are stacked. Heat and pressure are applied to the stack to bond layers together. Low temperature (<1000° C., or <900° C.) sintering is then performed. The sintered stacks are sawn to final dimensions and post fire processing completed as needed.

Multilayer structures useful in automotive applications may have about 5 ceramic layers, for example 3-7 or 4-6. In RF applications, a structure may have 10-25 ceramic layers. As a wiring substrate, 5-8 ceramic layers may be used.

Dielectric Pastes. A paste for forming the dielectric layers can be obtained by mixing an organic vehicle with a raw dielectric material, as disclosed herein. Also useful are precursor compounds (e.g. carbonates, nitrates, sulfates, phosphates) that convert to such oxides and composite oxides upon firing, as stated hereinabove. The dielectric material is obtained by selecting compounds containing these oxides, or precursors of these oxides, and mixing them in the appropriate proportions. The proportion of such compounds in the raw dielectric material is determined such that after firing, the desired dielectric layer composition may be obtained. The raw dielectric material (as disclosed elsewhere herein) is generally used in powder form having a mean particle size of about 0.1 to about 3 microns, and more preferably about 1 micron or less.

Organic Vehicle. The pastes herein include an organics portion. The organics portion is or includes an organic vehicle, which is a binder in an organic solvent or a binder in water. The binder is chosen to afford desired green strength or other desired properties of the green paste or tape. Binders such as ethyl cellulose, polyvinyl butanol, ethyl cellulose, and hydroxypropyl cellulose, and combinations thereof are appropriate together with a solvent. A resin such as an acrylic resin may be used in the vehicle. The organic solvent may be selected in accordance with a particular application method (i.e., tape casting, printing or sheeting), from organic solvents such as ester alcohols, for example tripropylene glycol n-butyl ether and dipropylene glycol dibenzoate, butyl carbitol, other solvents such as acetone, toluene, ethanol, diethylene glycol butyl ether; 2,2,4-trimethyl pentanediol monoisobutyrate (Texanol®); alpha-terpineol; beta-terpineol; gamma terpineol; tridecyl alcohol; diethylene glycol ethyl ether (Carbitol®), diethylene glycol butyl ether (Butyl Carbitol®) and propylene glycol; and blends thereof, Products sold under the Texanol® trademark are available from Eastman Chemical Company, Kingsport, Tenn.; those sold under the Dowanol® and Carbitol® trademarks are available from Dow Chemical Co., Midland, Mich. A rheological agent (thixotropic agent) may be included such as castor or its hydrogenated derivatives. The organics of the invention are Phthalate free.

Filler. In order to minimize expansion mismatch between tape layers of differing dielectric compositions, fillers such as cordierite, alumina, zircon, fused silica, aluminosilicates and combinations thereof may be added to one or more dielectric pastes herein in an amount of 1-30 wt %, preferably 2-20 wt % and more preferably 2-15 wt %.

Firing. The dielectric stack (two or more layers) is then fired in an atmosphere, which is determined according to the type of conductor in the internal electrode layer-forming paste. The conductors contemplated herein include silver, a noble metal, hence the conductors herein may be fired in the ambient atmosphere.

Applications for the LTCC compositions and devices disclosed herein include band pass filters, (high pass or low pass), wireless transmitters and receivers for telecommunications including cellular applications, power amplifier modules (PAM), RF front end modules (FEM), WiMAX2 modules, LTE-advanced modules, transmission control units (TCU), electronic power steering (EPS), engine management systems (EMS), various sensor modules, radar modules, pressure sensors, camera modules, small outline tuner modules, thin profile modules for devices and components, and IC tester boards. Band-pass filters contain two major parts, one a capacitor and the other an inductor. Low K material is good for designing the inductor, but not suitable for designing a capacitor due the requirement for more active area to generate sufficient capacitance. High K material will result in the opposite.

### EXAMPLES

The following examples are provided to illustrate preferred aspects of the invention and are not intended to limit the scope of the invention.

As seen in the Table 2 below, appropriate amounts of Mg(OH)₂, and SiO₂, are mixed and then milled together in an aqueous medium to a particle size D₅₀ of about 0.2 to 1.5 μm. This slurry is dried, and then calcined at about 800 to 1250° C. for about 1 to 10 hours to form the host material including MgO and SiO₂. The resultant host material is then mechanically pulverized and mixed with fluxing agents and dopants (see Table 3) and again milled in an aqueous medium to a particle size D₅₀ of about 0.5 to 1.0 μm. The milled ceramic powder is dried and pulverized to produce a finely divided powder. The resultant powder is pressed into cylindrical pellets and fired at a temperature range of about 825-880° C. for about 30 minutes. Formulations are given in weight percent.

TABLE 2
Embodiments of the M7 Host composition in weight %

| Oxide | I | II | III | IV |
|---|---|---|---|---|
| MgO | 49-65 | 53-61 | 56-59 | 57.295 |
| SiO₂ | 37-51 | 39-47 | 41-44 | 42.705 |

TABLE 3
M7 Dielectric Formulations in weight %

| Host | 85-95 | 87-92 | 88-91 |
|---|---|---|---|
| H₃BO₃ | 2.5-6 | 3-5 | 3.3-4.5 |
| CuO | 0.01-1 | 0.05-0.5 | 0.1-0.3 |
| LiF | 0.5-3 | 0.8-1.9 | 1-1.6 |
| CaF₂ | 3-7 | 3.8-5.4 | 4.4-5.1 |

The 825° C. fired properties of the M7 LTCC dielectric are summarized in Table 4. The green tape is made by combining the M7 dielectric powder (as disclosed in Tables 2 and 3) pulverized and milled to a particle size D₅₀ of about 0.5 to 1.0 μm with dispersant, binder, plasticizer and solvents, milling to form a castable slip, casting the slip onto a mylar carrier film and drying it to form a flexible, punch-able ceramic green tape, 50 to 125 microns thick.

TABLE 4
M7 LTCC Dielectric 825° C. Fired Properties

| Property | Value |
|---|---|
| Green Tape Thickness (μm) | 50-125 |
| XY shrink (green-to-fired) | 16.86% |
| Z shrink (green-to-fired) | 26.86% |
| Flexural Strength (Mpa) | 294 |
| Fired Density (g/cc) | 3.12 |
| Coefficient of Thermal Expansion (ppm/° K.) | 10.9 |
| K at 15.83 GHz | 7.07 |
| Q at 15.83 GHz | 1631 |
| Loss Tangent at 15.83 GHz | 0.0006 |
| IR (ohm) @ 50 V DC bias, Room Temperature | >10¹³ |
| Breakdown Voltage (V/micron) | 167 |
| Thermal Conductivity (W/mK) RT-200° C. | 4-5 |

Green tape slip formulations are shown in Table 5. Via holes with a diameter in the range of 0.15-0.51 mm are punched into the ceramic green tape and then filled with Ag paste to enable electrical connections between the ceramic layers. The conductors (surface, buried and via) are screen or stencil printed on the green tape and multiple printed layers are laminated together at 3000 psi/70° C./10 min to form multilayer parts which are fired at 825-850° C. to densify the ceramic tape and Ag conductors.

TABLE 5
M7 Dielectric Slip Formulations

| Material weight % | | | |
|---|---|---|---|
| (total = 100%) | A | B | C |
| M7 Powder | 50.64-56.32 | 49.13-56.87 | 51.89-54.95 |
| Polyvinyl Butyral | 6.79-8.44 | 6.45-8.85 | 6.92-8.00 |
| Resin | | | |
| Triethylene Glycol Bis | 2.70-3.47 | 2.62-3.61 | 2.81-3.35 |
| (2-ethylhexanoate) | | | |
| Ethanol | 11.41-12.52 | 11.05-12.75 | 11.75-12.25 |
| Xylene | 11.23-12.38 | 10.98-12.46 | 11.71-12.29 |
| Methyl Ethyl Ketone | 11.59-12.67 | 11.43-12.91 | 11.65-12.43 |

Thick film Ag conductor pastes compatible with the green tape and cofirable at 825-850° C. were also developed. The properties of the cofired Ag conductors are summarized in Table 6. The surface Ag conductor is designed to be electroless Ni and Au platable.

TABLE 6
M7 LTCC Ag Conductors

| Ag Paste Product | Surface | Internal | Via |
|---|---|---|---|
| Name | Formula 1 | Formula 3 | Formula 5 |
| Fired thickness (μm) | 5-10 | 5-10 | 0.15-0.51 mm |
| | | | diameter |
| Resistivity | 0.80 | 1.1 | |
| (mΩ/sq@ 25 μm) | | | |
| Viscosity Pa · S | 219.7 @2.5 rpm | 131.2 @5 rpm | 47 @5 rpm |
| (Brookfield 2HB, | | | |
| CP51; down curve) | | | |
| Solids Wt % | 73.12 | 73.3 | 81.3-82.6 |

The formulations for the Ag conductor pastes (surface, buried and via) for which properties are shown in the Table 6 above are presented in Tables 7-9. The Ag conductors are made by mixing together Ag powder(s) with filler materials (ceramic and/or glass), organic vehicle, dispersant and solvent and then 3-roll milling to form a thick film paste which is screen printed onto to the ceramic green tape and then dried at 125° C. EG2807 glass powder and L8 VWG glass powders are commercially available from Ferro Corporation, Cleveland, Ohio.

Multilayer parts are made by stacking and isostatically laminating Ag-printed green tape layers and then firing in air at 825-850° C.

TABLE 7
Surface Ag Paste Compositions

| Material in weight % | Formula 1 | Formula 2 |
|---|---|---|
| M7 Dielectric Powder | 3.35 | 1.43 |
| EG2807 Glass Powder | 4.02 | -0- |
| L8 VWG Powder | -0- | 6.80 |
| Ag Flake 1; D₅₀ 0.6-0.8 μm | 12.51 | 12.39 |
| Ag Powder 1; D₅₀ 3.0-5.0 μm | 12.51 | 12.39 |
| Ag Powder 2; D₅₀ 0.7-2.0 μm | 40.72 | 40.26 |
| GGS-20 Vehicle | 22.54 | 21.85 |
| Ester Alcohol | 4.05 | 4.57 |
| Oleoyl Sarcosine | 0.29 | 0.31 |
| Total | 100.00% | 100.00% |

TABLE 8
Inner Layer Ag Formulations

| Material in weight % | Formula 3 | Formula 4 | Formula X | Formula Y | Formula Z |
|---|---|---|---|---|---|
| Ag Powder 2; D₅₀ 0.7-2.0 μm | 40.53 | 40.63 | 40-50 | 42-47 | 42-47 |
| Ag Powder 3; D₅₀ 0.2-0.5 μm | 23.94 | 24.01 | 23-25 | 23.5-24.5 | 23.5-24.5 |
| M7 Dielectric Powder | 8.81 | 1.43 | 7-11 | 8-10 | 1-3 |
| L8 VWG Powder | -0- | 7.40 | -0- | -0- | 6-9 |
| GGS-20 Vehicle | 22.04 | 22.10 | 20-24 | 21-23 | 20-24 |
| Oleoyl Sarcosine | 0.48 | 0.48 | 0.2-0.8 | 0.3-0.7 | 0.3-0.7 |
| Ester Alcohol | 4.20 | 3.95 | 3.5-5 | 3.2-4.5 | 3.5-5 |
| Total | 100.00% | 100.00% | 100.00% | 100.00% | 100.00% |

TABLE 9
Via Ag Paste Composition

| Material in weight % | Formula 5 |
|---|---|
| Ag Powder 4; Avg P.S. 1.5-3.5 μm | 24.79-25.18 |
| Ag Powder 5; Avg P.S. 2.5-4.0 μm | 41.21-41.86 |
| Fused Quartz Powder | 13.10-14.05 |
| Borosilicate Glass Powder | 1.48-2.18 |
| Oleoyl Sarcosine | 0.31 |
| Vehicle 150 INT | 17.13-18.42 |

Organic Vehicles with which the pastes or tapes of the invention are produced are shown in Tables 10 and 11.

TABLE 10
GGS-20 Vehicle Composition

| Material | Weight % |
|---|---|
| Ethyl Cellulose Resin | 19.4 |
| Acrylic Resin | 1.6 |
| Ester Alcohol | 79.0 |
| Total | 100.0% |

TABLE 11
Vehicle 150 INT Composition

| Material | Weight % |
|---|---|
| Monoterpene Alcohol | 44.10 |
| Triprpopylene Glycol n-Butyl Ether | 11.03 |
| Dipropylene Glycol Dibenzoate | 33.07 |
| Ethyl Cellulose Resin | 9.80 |
| Castor Oil Derivative | 2.00 |
| Total | 100% |

In another embodiment, as shown in Table 12, a surface Ag conductor paste may include 11.5-13.2 wt % first silver flake, 11.5-13.2 wt % first silver powder, and 37-43 wt % second silver powder. The surface Ag conductor may further include 3-6 wt % dielectric powder, and 2-4.5 wt % EG 2807 glass powder (commercially available; from Ferro Corporation, Cleveland, Ohio). In yet another embodiment, a surface Ag conductor may include 11.5-13.2 wt % first silver flake, 11.5-13.2 wt % first silver powder, and 37-43 wt % second silver powder, 2.5-5.5 wt % dielectric powder, and 2.5-4.5 wt % EG 2807 glass powder. In still another embodiment, a surface Ag conductor paste may include 11.7-13.0 wt % first silver flake, 11.7-13.0 wt % first silver powder, and 38-42 wt % second silver powder. The surface Ag conductor may further include 3.0-5.0 wt %, preferably 3.5-5.0 wt % dielectric powder, and 2.5-4.0 wt %, preferably 2.6-3.8 wt % EG 2807 glass powder. The first silver flake, first silver powder, and second silver powder may have any combination of D₅₀ (or average particle size) set forth elsewhere herein.

TABLE 12
Surface Ag Paste Compositions

| Material in weight % | Formula 13 |
|---|---|
| M7 Dielectric Powder | 3-6 |
| EG2807 Glass Powder | 2-4.5 |
| Ag Flake 1 | 11.5-13.2 |
| Ag Powder 1 | 11.5-13.2 |
| Ag Powder 2 | 37-43 |
| GGS-20 Vehicle | 21-31 |
| Ester Alcohol | 4-5 |
| Oleoyl Sarcosine | 0.1-0.4 |
| Total | 100% |

The ranges for components of via Ag conductors are shown in Table 13. A via Ag conductor paste may include 21.5-28.5 wt %, preferably 23-25 wt % fourth silver powder and 37.1-40.9 wt %, preferably 38-40 wt % fifth silver powder. A via Ag conductor may further include a 13.5-17.5, preferably 14.5-17 w % dielectric powder. A via Ag conductor paste further may include 1.31-4.5 wt %, preferably 2-4.5 wt % of at least one of EG0024 glass powder, EG2810 glass powder, and EGO912 glass powder (Ca-Borosilicate Glass with Softening Point 650-750° C.). The foregoing EG0024 and EG2810 glass powders are commercially available from Ferro Corporation, Cleveland, Ohio.

TABLE 13
Via Ag Paste Composition

| Material in weight % | Formula V2 |
|---|---|
| Ag Powder 4 | 21.5-28.5 |
| Ag Powder 5 | 37.1-41.9 |
| Cordierite Powder | 13.5-17.5 |
| EG0024 Glass Powder or EG2810 Glass | 1.31-4.50 |
| Powder or EG0912 Glass Powder | |
| Oleoyl Sarcosine | 0.34-0.7 |
| Vehicle 150 INT | 11.5-14.8 |
| Other additives | 0.1-7.75 |
| Total | 100 wt % |

In one embodiment, the D₅₀ for Ag Flake 1 is within the range 0.1-1.5 μm, preferably 0.1-1.1 μm, more preferably 0.4-0.9 μm, and most preferably 0.6-0.8 μm. The D₅₀ for Ag Powder 1 is within the range 2.1-8 μm, preferably 2.3-7 μm, more preferably 2.6-6 μm, and most preferably 3-5 μm. The D₅₀ for Ag Powder 2 is within the range 0.4-3 μm, preferably 0.5-2.8 μm, more preferably 0.6-2.5 μm, and most preferably 0.7-2 μm. The D₅₀ for Ag Powder 3 is within the range 0.05-0.8 μm, preferably 0.05-0.6 μm, more preferably 0.1-0.55 μm, and most preferably 0.2-0.5 μm. An average particle size for Ag Powder 4 is within the range 0.7-5 μm, preferably 0.8-4 μm, more preferably 1-3.8 μm, and most preferably 1.5-3.5 μm. An average particle size for Ag Powder 5 is within the range 1.5-6 μm, preferably 1.7-5 μm, more preferably 2-4.5 μm, and most preferably 2.5-4 μm.

The invention is further defined by the following items.
Item 1: A composition comprising:
   (a) 85-95 wt % of a calcined host comprising:
      1. 49-65 wt % MgO,
      2. 35-51 wt % SiO₂, and
      3. none of the following in any form: lead, cadmium, zinc, manganese, bismuth, titanium, arsenic, and mercury, and
   (b) additives comprising:
      1. 2.5-6 wt % H₃BO₃,
      2. 0.01-0.1 wt % CuO
      3. 0.5-3 wt % of at least one alkali fluoride, and
      4. 3-7 wt % of at least one alkaline-earth fluoride, and
   (c) none of the following in any form: lead, cadmium, zinc, manganese, bismuth, titanium, arsenic, and mercury, and
   (d) wherein the sum of (a) and (b) is 100 weight percent.
Item 2: The composition of item 1, wherein
   (a) the calcined host comprises
      1. 53-61 wt % MgO,
      2. 39-47 wt % SiO₂, and
      3. none of the following in any form: lead, cadmium, zinc, manganese, bismuth, titanium, arsenic, and mercury, and
   (b) the additives include
      1. 3-5 wt % H₃BO₃,
      2. 0.05-0.5 wt % CuO
      3. 0.8-1.9 wt % of at least one alkali fluoride, and
      4. 3.8-5.4 wt % of at least one alkaline-earth fluoride.
Item 3: The powder composition of any of items 1 or 2, wherein
   (a) the calcined host comprises
      1. 56-59 wt % MgO,
      2. 41-44 wt % SiO₂, and
      3. none of the following in any form: lead, cadmium, zinc, manganese, bismuth, titanium, arsenic, and mercury, and
   (b) the additives include
      1. 3.3-4.5 wt % H₃BO₃,
      2. 0.1-0.3 wt % CuO
      3. 1-1.6 wt % of at least one alkali fluoride, and
      4. 4.4-5.1 wt % of at least one alkaline-earth fluoride.
Item 4: The powder composition of any of items 1-3 wherein the composition includes 87-92 wt % of the host.
Item 5: The powder composition of any of items 1-3 wherein the composition includes 88-91 wt % of the host.
Item 6: A slip for forming a dielectric tape or paste comprising:
   (a) 50-60 wt % of a dielectric powder,
   (b) 5-10 wt % of a plasticizer,
   (c) 30-45 wt % of at least one solvent.
Item 7: A silver paste comprising:
   (a) a first silver flake having a particle size D₅₀ of 0.6-0.8 μm,
   (b) a first silver powder having a D₅₀ of 3-5 μm,
   (c) a second silver powder having a D₅₀ of 0.7-2 μm,
   (d) a dielectric powder,
   (e) an optional glass frit, and
   (f) an organic component.
Item 8: A silver paste comprising:
   (a) a second silver powder having a D₅₀ of 0.7-2 μm,
   (b) a third silver powder having a D₅₀ of 0.2-5 μm,
   (c) a dielectric powder,
   (d) an optional glass frit, and
   (e) an organic component.
Item 9: A silver paste comprising:
   (a) a fourth silver powder having an average particle size of 1.5-3.5 μm,
   (b) a fifth silver powder having an average particle size of 2.5-4 μm,
   (c) a dielectric powder,
   (d) an optional glass frit, and
   (e) an organic component.
Item 10: An LTCC component comprising: sintered plurality of alternating layers of
   (a) a composition of any of items 1-5 with
   (b) a conductor of any of items 7-9.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1: A composition comprising:
(a) 85-95 wt % of a calcined host comprising:
1. 49-65 wt % MgO,
2. 35-51 wt % SiO₂, and
3. is free of at least any one of the following in any form: lead, cadmium, zinc, manganese, bismuth, titanium, arsenic, and mercury, and
(b) additives comprising:
1. 2.5-6 wt % H₃BO₃,
2. 0.01-0.1 wt % CuO
3. 0.5-3 wt % of at least one alkali fluoride, and
4. 3-7 wt % of at least one alkaline-earth fluoride, and
(c) is free of at least any one of the following in any form: lead, cadmium, zinc, manganese, bismuth, titanium, arsenic, and mercury, and
(d) wherein the sum of (a) and (b) is 100 weight percent.

2: The composition of claim 1, wherein
(a) the calcined host comprises
1. 53-61 wt % MgO,
2. 39-47 wt % SiO₂, and
3. is free of at least any one of none of the following in any form: lead, cadmium, zinc, manganese, bismuth, titanium, arsenic, and mercury, and
(b) the additives include
1. 3-5 wt % H₃BO₃,
2. 0.05-0.5 wt % CuO
3. 0.8-1.9 wt % of at least one alkali fluoride, and
4. 3.8-5.4 wt % of at least one alkaline-earth fluoride.

3: The composition of claim 1 or 2, wherein
(a) the calcined host comprises
1. 56-59 wt % MgO,
2. 41-44 wt % SiO₂, and
3. is free of at least any one of the following in any form: lead, cadmium, zinc, manganese, bismuth, titanium, arsenic, and mercury, and
(b) the additives include
1. 3.3-4.5 wt % H₃BO₃,
2. 0.1-0.3 wt % CuO
3. 1-1.6 wt % of at least one alkali fluoride, and
4. 4-5.1 wt % of at least one alkaline-earth fluoride.

4: The composition of any of claims 1-3 wherein the composition includes 87-92 wt % of the calcined host.

5: The composition of any of claims 1-3 wherein the composition includes 88-91 wt % of the calcined host.

6: The composition of any of claims 1-5, wherein the at least one alkali fluoride comprises lithium fluoride, and the at least one alkaline-earth fluoride comprises calcium fluoride.

7: The composition of any of claims 1-6, wherein the composition is free of all of the following in any form: lead, cadmium, zinc, manganese, bismuth, titanium, arsenic, and mercury.

8: A slip for forming a dielectric tape or paste comprising:
(a) 49.13-56.87 wt % of a dielectric powder comprising the composition of any of claims 1 to 7,
(b) 2.62-3.61 wt % of a plasticizer comprising trimethylene glycol bis (2-ethylhexanoate), and
(c) 33.46-38.12 wt % of at least one solvent selected from the group consisting of ethanol, xylene, and methyl ethyl ketone, and
(d) 6.45-8.85 wt % resin comprising polyvinyl butyral, and
(e) wherein the sum of (a)-(d) is 100 weight percent.

9: The slip of claim 8, wherein the at least one solvent comprises all of ethanol, xylene, and methyl ethyl ketone.

10: A silver paste comprising:
(a) 11.5-13.2 wt % first silver flake having a particle size D₅₀ in the range of 0.6-0.8 μm,
(b) 11.5-13.2 wt % first silver powder having a D₅₀ in the range of 3-5 μm,
(c) 37-43 wt % second silver powder having a D₅₀ in the range of 0.7-2 μm,
(d) 3-6 wt % dielectric powder, wherein the dielectric powder comprises the composition of any of claims 1 to 7,
(e) 2-4.5 wt % glass frit, and
(f) 25.1-36.4 wt % organic vehicle, and
(g) wherein the sum of (a)-(f) is 100 weight percent.

11: A silver paste comprising:
(a) 12.39 wt % first silver flake,
(b) 12.39 wt % first silver powder,
(c) 40.26 wt % second silver powder,
(d) 1.43 wt % dielectric powder,
(e) 6.80 wt % glass frit, and
(f) 26.73 wt % organic vehicle, and
(g) wherein the sum of (a)-(f) is 100 weight percent.

12: A silver paste comprising:
(a) 40-50 wt % second silver powder having a D₅₀ in the range of 0.7-2 μm,
(b) 23-25 wt % third silver powder having a D₅₀ in the range of 0.2-5 μm,
(c) 7-11 wt % dielectric powder, wherein the dielectric powder comprises the composition of any of claims 1 to 7, and
(d) 23.7-29.8 wt % organic vehicle, and
(e) wherein the sum of (a)-(d) is 100 weight percent.

13: A silver paste comprising:
(a) 42-47 wt % second silver powder having a D₅₀ in the range of 0.7-2 μm,
(b) 23.5-24.5 wt % third silver powder having a D₅₀ in the range of 0.2-5 μm,
(c) 1-3 wt % dielectric powder, wherein the dielectric powder comprises the composition of any of claims 1 to 7,
(d) 6-9 wt % glass frit, and
(e) 23.8-29.7 wt % organic vehicle, and
(f) wherein the sum of (a)-(e) is 100 weight percent.

14: A silver paste comprising:
(a) 21.5-28.5 wt % fourth silver powder having an average particle size in the range of 1.5-3.5 μm,
(b) 37.1-41.9 wt % fifth silver powder having an average particle size in the range of 2.5-4 μm,
(c) 1.31-4.5 wt % borosilicate glass frit,
(d) 11.94-23.25 wt % organic vehicle, and
(e) 13.5-17.5 wt % cordierite powder, and
(f) wherein the sum of (a)-(e) is 100 weight percent.

15: A silver paste comprising:
(a) 24.79-25.18 wt % fourth silver powder,
(b) 41.21-41.86 wt % fifth silver powder,
(c) 1.48-2.18 wt % borosilicate glass frit,
(d) 17.44-18.73 wt % organic vehicle, and
(e) 13.10-14.05 wt % quartz powder, and
(f) wherein the sum of (a)-(e) is 100 weight percent.

16: An LTCC component comprising a sintered plurality of alternating layers of
(a) a composition of any of claims 1-7, and
(b) a conductor of any of claims 10-15.
